(19) United States
(12) Patent Application Publication
(10) Pub. No.: US 2008/0161449 A1
(43) Pub. Date: Jul. 3, 2008

(54) Biodegradable Polyester Mixture

(75) Inventors: Motonori Yamamoto, Mannheim (DE); Dietmar Heufel, Zwingenberg (DE); Dirk Starke, Bad Durkheim (DE); Uwe Witt, Mutterstadt (DE); Gabriel Skupin, Speyer (DE)

Correspondence Address: CONNOLLY BOVE LODGE & HUTZ LLP, 1875 EYE STREET, N.W., SUITE 1100, WASHINGTON, DC, 20036, US

(73) Assignee: ASF Aktiengesellschaft, Ludwigshsfen (DE)

(21) Appl. No.: 10/567,107

(22) PCT Filed: Aug. 4, 2004
(86) PCT No.: PCT/EP04/08717

§ 371 Date: May 3, 2006

(30) Foreign Application Priority Data
Aug. 6, 2003 (DE) 103 36 387.4

(51) Int. Cl. C08K 5/10; C08L 1/02; C08L 3/02

(52) U.S. Cl. 524/35; 524/317; 524/47

(57) ABSTRACT

The present invention relates to biodegradable polyester mixtures comprising
from 5% to 80% by weight, based on the total weight of components i to ii, of at least one polyester based on aliphatic and aromatic dicarboxylic acids and an aliphatic dihydroxy compound (component i) and
from 20% to 95% by weight, based on the total weight of components i to ii, of at least one renewable raw material (component ii) and
from 0.1% to 15% by weight, based on the total weight of components i to ii, of a component iii which is capable of forming covalent bonds with both component i and component ii.

The present invention further relates to processes for producing biodegradable polyester mixtures, to the use of biodegradable polyester mixtures for producing blends, moldings, films, sheets or fibers and also to blends, moldings, films, sheets or fibers comprising biodegradable polyester mixtures.

The present invention relates to biodegradable polyester mixtures comprising

from 5% to 80% by weight, based on the total weight of components i to ii, of at least one polyester based on aliphatic and aromatic dicarboxylic acids and an aliphatic dihydroxy compound (component i) and

from 20% to 95% by weight, based on the total weight of components i to ii, of at least one renewable raw material (component ii) and

from 0.1% to 15% by weight, based on the total weight of components i to ii, of a component iii which is capable of forming covalent bonds with both component i and component ii.

The present invention further relates to processes for producing biodegradable polyester mixtures, to the use of biodegradable polyester mixtures for producing blends, moldings, films, sheets or fibers and also to blends, moldings, films, sheets or fibers comprising biodegradable polyester mixtures.

Biodegradable mixtures of synthetically produced polymeric materials and naturally occurring, usually high molecular weight or polymeric materials on a vegetable base, i.e., renewable raw materials, are known. Such mixtures constitute an ideal combination of desirable properties of the individual components, for example the generally good processing and mechanical properties of synthetic polymers with the usually lower cost and ecologically sound production and disposal of naturally occurring materials.

In practice, however, it is often difficult to achieve the desired combination of properties. Thus, although it is commercially and ecologically desirable to aim to maximize the fraction of inexpensive and ecologically sound renewables in the mixtures, such mixtures possess inadequate processing or mechanical properties because of the often only poor miscibility and the low fraction of synthetic polymer.

Biodegradable “interpolymer” blends formed from synthetic and natural polymers that exhibit improved miscibility of the components are disclosed in WO 93/23456. This reference teaches that virtually all synthetic polymers—even nonbiodegradable ones—can be used, provided they have a functional group which, on reactive blending at elevated temperatures, form covalent and physical bonds with the natural polymer, for example carbohydrate such as starch or cellulose. But the disadvantage with these “interpolymers” or blends is that there is biodegradability only for the bonds between synthetic polymer and natural polymer as well as for the natural polymeric component; any fractions of synthetic, nonbiodegradable polymers remain nonbiodegradable. The “interpolymers” or blends disclosed in WO 93/23456 are thus only partly biodegradable.

Fully biodegradable mixtures of aliphatic polyesters comprising aliphatic hydroxy carboxylic acid residues and biomass materials are described by EP-A2 897 943. The improved miscibility of these components is enabled by the presence of an unsaturated carboxylic acid which forms covalent bonds to the aliphatic polyesters at one end and the biomass materials at the other during a heating and kneading operation. The entire mixture and also the covalently bound aliphatic polyesters comprising aliphatic hydroxy carboxylic acid residues are indeed fully biodegradable; however, the degradation rate of the mixtures (i.e., the fraction of degraded material within a defined time) could do with improvement for many applications.

If is an object of the present invention to provide biodegradable polymer mixtures which contain a high fraction of inexpensive and ecologically sound renewables and which have improved degradation rates as well as good processing and mechanical properties.

We have found that this object is achieved by the biodegradable polyester mixtures which were defined at the outset and which will now be more particularly described.

Component i for producing the inventive biodegradable polyester mixtures can in principle be any polyester which is based on aliphatic and aromatic dicarboxylic acids and an aliphatic dihydroxy compound, viz., a polyester known as a partly aromatic polyester. Mixtures of plural such polyesters are of course also suitable for use as component i.

As used herein, the term “partly aromatic polyesters” shall also comprehend polyester derivatives such as polyetheresters, polyesteramides or polyetheresteramides. Useful partly aromatic polyesters include linear non-chain-extended polyesters (WO 92/09654). Preference is given to chain-extended and/or branched partly aromatic polyesters. The latter are known from the references cited at the beginning, WO 96/15173 to 15176, 21689 to 21692, 25446, 25448 or WO 98/12242, which are expressly incorporated herein by reference. Mixtures of differently partly aromatic polyesters are similarly contemplated.

The particularly preferred partly aromatic polyesters include polyesters comprising as essential components

A) an acid component comprising
a1) from 30 to 99 mol % of at least one aliphatic or at least one cycloaliphatic dicarboxylic acid or its ester-forming derivatives or mixtures thereof
a2) from 1 to 70 mol % of at least one aromatic dicarboxylic acid or its ester-forming derivative or mixtures thereof and
a3) from 0 to 5 mol % of a sulfonated compound,

B) a diol component selected from at least one C₂- to C₁₂-alkanediol and at least one C₅- to C₁₀-cycloalkanediol or mixtures thereof
and if desired additionally one or more components selected from

C) a component selected from
c1) at least one dihydroxy compound which comprises ether functions and has the formula I

HO—[(CH₂)ₙ—O]ₘ—H (I)

where n is 2, 3 or 4 and m is an integer from 2 to 250,
c2) at least one hydroxy carboxylic acid of the formula IIa or IIb

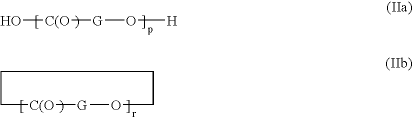

where p is an integer from 1 to 1500, r is an integer from 1 to 4 and G is a radical selected from the group consisting of phenylene, -(CH2)q-, where q is an integer from 1 to 5, —C(R)H— and —C(R)HCH₂, where R is methyl or ethyl,
c3) at least one amino-C₂- to C₁₂-alkanol or at least one amino-C₅- to C₁₀-cycloalkanol or mixtures thereof
c4) at least one diamino-C₁- to C₈-alkane
c5) at least one 2,2′-bisoxazoline of the general formula III

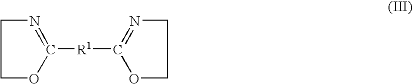

where R¹ is a single bond, a (CH₂)_{z}-alkylene group, where z=2, 3 or 4, or a phenylene group
c6) at least one amino carboxylic acid selected from the group consisting of the natural amino acids, polyamides obtainable by polycondensation of a dicarboxylic acid having from 4 to 6 carbon atoms and a diamine having from 4 to 10 carbon atoms, compounds of the formulae IV a and IVb

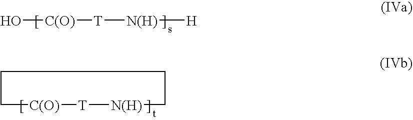

where s is an integer from 1 to 1500, t is an. integer from 1 to 4 and T is a radical selected from the group consisting of phenylene, -(CH₂)ᵤ-, where u is an integer from 1 to 12, —C(R²)H— and —C(R²)HCH₂, where R² is methyl or ethyl,
and polyoxazolines containing the repeat unit V

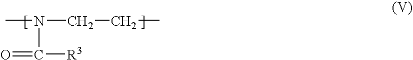

where R³ is hydrogen, C₁-C₆-alkyl, C₅-C₈-cycloalkyl, unsubstituted or C₁-C₄-alkyl-monosubstituted, -disubstituted or -trisubstituted phenyl or is tetrahydrofuryl,
or mixtures of c1 to c6 and

D) a component selected from
d1) at least one compound having at least three groups capable of ester formation,
d2) at least one isocyanate
d3) at least one divinyl ether.
or mixtures of d1) to d3).

The acid component A of the partly aromatic polyesters comprises, in a preferred embodiment, from 30 to 70, and especially from 40 to 60 mol % of a1 and from 30 to 70, and especially from 40 to 60 mol % of a2.

Useful aliphatic acids and the corresponding derivatives a1 are generally those having from 2 to 10 carbon atoms and preferably from 4 to 6 carbon atoms. They may each be linear or branched. Cycloaliphatic dicarboxylic acids useful in the present invention are generally those having from 7 to 10 carbon atoms and especially those having 8 carbon atoms. In principle, however, dicarboxylic acids having a larger number of carbon atoms, for example up to 30 carbon atoms, can also be used.

Specific examples are: malonic acid, succinic acid, glutaric acid, 2-methylglutaric acid, 3-methylglutaric acid, adipic acid, pimelic acid, azelaic acid, sebacic acid, fumaric acid, 2,2-dimethylglutaric acid, suberic acid, 1,3-cyclopentanedicarboxylic acid, 1,4-cyclohexanedicarboxylic acid, 1,3-cyclohexanedicarboxylic acid, diglycolic acid, itaconic acid, maleic acid and 2,5-norbornanedicarboxylic acid.

Similarly useful ester-forming derivatives of the abovementioned aliphatic or cycloaliphatic dicarboxylic acids are in particular the di-C₁- to C₆-alkyl esters, such as dimethyl, diethyl, di-n-propyl, diisopropyl, di-n-butyl, diisobutyl, di-t-butyl, di-n-pentyl, diisopentyl or di-n-hexyl ester. Anhydrides of dicarboxylic acids can likewise be used.

Dicarboxylic acids or their ester-forming derivatives can be used singly or as a mixture of two or more thereof.

Particular preference is given to using adipic acid or sebacic acid or their respective ester-forming derivatives or mixtures thereof. Particular preference is given to using adipic acid or its ester-forming derivatives, such as its alkyl esters or mixtures thereof.

Useful aromatic dicarboxylic acids a2 are generally those having from 8 to 12 carbon atoms and preferably those having 8 carbon atoms. Examples which may be mentioned are terephthalic acid, isophthalic acid, 2,6-naphthoic acid and 1,5-naphthoic acid and also ester-forming derivatives thereof. Especially the di-C₁-C₆-alkyl esters, for example dimethyl, diethyl, di-n-propyl, diisopropyl, di-n-butyl, diisobutyl, di-t-butyl, di-n-pentyl, diisopentyl or di-n-hexyl ester, may be mentioned. The anhydrides of the dicarboxylic acids a2 are similarly useful ester-forming derivatives.

In principle, however, it is also possible to use aromatic dicarboxylic acids a2 having a larger number of carbon atoms, for example up to 20 carbon atoms.

The aromatic dicarboxylic acids or their ester-forming derivatives a2 can be used singly or as a mixture of two or more thereof. Particular preference is given to the use of terephthalic acid or its ester-forming derivatives such as dimethyl terephthalate.

The sulfonated compound used will usually be an alkali or alkaline earth metal salt of a sulfonated dicarboxylic acid or its ester-forming derivatives, preferably alkali metal salts of 5-sulphoisophthalic acid or mixtures thereof, the sodium salt being particularly preferred.

In one of the preferred embodiments, the acid component A comprises from 40 to 60 mol % of al, from 40 to 60 mol % of a2 and from 0 to 2 mol % of a3. In a further preferred embodiment, the acid component A comprises from 40 to 59.9 mol % of a1, from 40 to 59.9 mol % of a2 and from 0.1 to 1 mol % of a3, especially from 40 to 59.8 mol % of al, from 40 to 59.8 mol % of a2 and from 0.2 to 0.5 mol % of a3.

In general, the diols B are selected from branched or linear alkanediols having from 2 to 12 carbon atoms, and preferably from 4 to 6 carbon atoms, or cycloalkanediols having from 5 to 10 carbon atoms.

Examples of useful alkanediols are ethylene glycol, 1,2-propanediol, 1,3-propanediol, 1,2-butanediol, 1,4-butanediol, 1,5-pentanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, especially ethylene glycol, 1,3-propanediol, 1,4-butanediol and 2,2-dimethyl-1,3-propanediol (neopentyl glycol); cyclopentanediol, 1,4-cyclohexanediol, 1,2-cyclohexanedimethanol, 1,3-cyclohexane-dimethanol, 1,4-cyclohexanedimethanol or 2,2,4,4-tetramethyl-1,3-cyclobutanediol. It is also possible to use mixtures of different alkanediols.

Depending on whether an excess of acid or OH end groups is desired, either component A or component B can be used in excess. In a preferred embodiment, the molar ratio of components A to B used can be in the range from 0.4:1 to 1.5:1 and preferably in the range from 0.6:1 to 1.1:1.

As well as the components A and B, the polyesters on which the inventive polyester mixtures are based may comprise further components.

Dihydroxy compounds c1 are preferably diethylene glycol, triethylene glycol, polyethylene glycol, polypropylene glycol and polytetrahydrofuran (poly-THF), more preferably diethylene glycol, triethylene glycol and polyethylene glycol, it also being possible to use mixtures thereof or compounds having different variables n (see formula I), for example polyethylene glycol which comprises propylene units (n=3), obtainable for example by conventional polymerization of first ethylene oxide and then with propylene oxide, more preferably a polymer based on polyethylene glycol having different n variables subject to the proviso that units formed from ethylene oxide predominate. The molecular weight (Mₙ) of the polyethylene glycol is generally in the range from 250 to 8000 and preferably in the range from 600 to 3000 g/mol.

In one of the preferred embodiments, for example, from 15 to 98 and preferably from 60 to 99.5 mol % of diols B and from 0.2 to 85 and preferably from 0.5 to 30 mol % of dihydroxy compounds c1, based on the molar amount of B and c1, can be used for produding partly aromatic polyesters.

In a preferred embodiment, the hydroxy carboxylic acid c2) used is: glycolic acid, D-, L-, D,L-lactic acid, 6-hydroxyhexanoic acid, their cyclic derivatives such as glycolide (1,4-dioxane-2,5-dione), D-, L-dilactide (3,6-dimethyl-1,4-dioxane-2,5-dione), p-hydroxybenzoic acid and also oligomers and polymers thereof, such as 3-polyhydroxybutyric acid, polyhydroxyvaleric acid, polylactide (obtainable for example as EcoPLA® from Cargill) and also a mixture of 3-polyhydroxybutyric acid and polyhydroxyvaleric acid (the latter is obtainable from Zeneca as Biopol®), particular preference for the production of partly aromatic polyesters being given to the low molecular weight and cyclic derivatives thereof.

The hydroxy carboxylic acids can be used for example in amounts of from 0.01% to 50% and preferably from 0.1% to 40% by weight based on the amount of A and B.

The amino-C₂-C₁₂-alkanol or amino-C₅-C₁₀-cyloalkanol (component c3), which shall also cover 4-aminomethylcyclohexanemethanol, is preferably an amino-C₂-C₆-alkanol such as 2-aminoethanol, 3-aminopropanol, 4-aminobutanol, 5-aminopentanol, 6-aminohexanol or an amino-C₅-C₆-cycloalkanol such as aminocyclopentanol and aminocyclohexanol or mixtures thereof.

The diamino-C₁-C₈-alkane (component c4) is preferably a diamino-C₄-C₆-alkane such as 1,4-diminobutane, 1,5-diaminopentane and 1,6-diaminohexane (hexamethylene-diamine, HMD).

In a preferred embodiment, from 0.5 to 99.5 mol % and preferably from 0.5 to 50 mol % of c3, based on the molar amount of B, and from 0 to 50 and preferably from 0 to 35 mol % of c4, based on the molar amount of B, can be used for producing partly aromatic polyesters.

The 2,2′-bisoxazolines c5 of the general formula III are generally obtainable by the process of Angew. Chem. Int. Edit., Vol. 11 (1972), 287-288. Particularly preferred bisoxazolines are those in which R¹ is a single bond, a (CH₂)_{z}-alkylene group, where z=2, 3 or 4, such as methylene, 1,2-ethanediyl, 1,3-propanediyl, 1,2-propanediyl, or a phenylene group. Particularly preferred bisoxazolines are 2,2′-bis(2-oxazoline), bis(2-oxazolinyl)methane, 1,2-bis(2-oxazolinyl)ethane, 1,3-bis(2-oxazolinyl)propane or 1,4-bis(2-oxazolinyl)butane, especially 1,4-bis(2-oxazolinyl)benzene, 1,2-bis(2-oxazolinyl)benzene or 1,3-bis(2-oxazolinyl)benzene.

Partly aromatic polyesters can be produced using for example from 70 to 98 mol % of B, up to 30 mol % of c3 and from 0.5 to 30 mol % of c4 and from 0.5 to 30 mol % of c5, each percentage being based on the sum total of the molar amounts of components B, c3, c4 and c5. In another preferred embodiment, it is possible to use from 0.1% to 5% and preferably from 0.2 to 4% by weight of c5, based on the total weight of A and B.

Component c6 can be a natural amino carboxylic acid. Natural amino carboxylic acids include valine, leucine, isoleucine, threonine, methionine, phenylalanine, tryptophan, lysine, alanine, arginine, aspartic acid, cysteine, glutamic acid, glycine, histidine, proline, serine, tryosine, asparagine or glutamine.

Preferred amino carboxylic acids of the general formulae IVa and IVb are those wherein s is an integer from 1 to 1000, t is an integer from 1 to 4, and preferably 1 or 2 and T is selected from the group consisting of phenylene and -(CH₂)ᵤ-, where u is 1, 5 or 12.

Furthermore, c6 can also be a polyoxazoline of the general formula V. But c6 can also be a mixture of different amino carboxylic acids and/or polyoxazolines.

In a preferred embodiment, c6 can be used in amounts from 0.01% to 50% and preferably from 0.1 to 40% by weight, based on the total amount of components A and B.

Further components, whose use for producing partly aromatic polyesters is optional, include compounds d1, which comprise at least three groups capable of ester formation.

The compounds d1 preferably comprise from three to ten functional groups capable of forming ester bonds. Particularly preferred compounds d1 have from three to six functional groups of this kind in the molecule, especially from three to six hydroxyl groups and/or carboxyl groups. Examples are:
tartaric acid, citric acid, malic acid;
trimethylolpropane, trimethylolethane;
pentaerythritol;
polyethertriols;
glycerol;
trimesic acid;
trimellitic acid, trimellitic anhydride;
pyromellitic acid, pyromellitic dianhydride; and
hydroxyisophthalic acid.

The amounts of compounds dl used are generally from 0.01 to 15, preferably from 0.05 to 10 and more preferably from 0.1 to 4 mol %, based on component A.

Component d2 is an isocyanate or a mixture of different isocyanates. Aromatic or aliphatic diisocyanates can be used. However, it is also possible to use isocyanates having a higher functionality.

An aromatic diisocyanate d2 for the purposes of the present invention is in particular

tolylene 2,4-diisocyanate, tolylene 2,6-diisocyanate, 2,2′-diphenylmethane diisocyanate, 2,4′-diphenylmethane diisocyanate, 4,4′-diphenylmethane diisocyanate, naphthylene 1,5-diisocyanate or xylylene diisocyanate.

Of these, 2,2′-, 2,4′- and also 4,4′-diphenylmethane diisocyanate are particularly preferred for use as a component d2. In general, the latter diisocyanates are used in the form of a mixture.

Tri(4-isocyanophenyl)methane is a useful trinuclear isocyanate d2. Polynuclear aromatic diisocyanates arise for example in the course of the production of mono- or binuclear diisocyanates.

Component d2 may comprise minor amounts, for example up to 5% by weight, based on the total weight of component d2, of urethione groups, for example for capping the isocyanate groups.

An aliphatic diisocyanate d2 for the purposes of the present invention is in particular a linear or branched alkylene diisocyanate or cycloalkylene diisocyanate having from 2 to 20 carbon atoms and preferably from 3 to 12 carbon atoms, for example 1,6-hexamethylene diisocyanate, isophorone diisocyanate or methylene bis(4-isocyanatocyclohexane). Particularly preferred aliphatic diisocyanates d2 are 1,6-hexamethylene diisocyanate and isophorone diisocyanate.

Preferred isocyanurates include aliphatic isocyanurates which are derived from alkylene diisocyanates or cycloalkylene diisocyanates having from 2 to 20 carbon atoms preferably from 3 to 12 carbon atoms, for example isophorone diisocyanate or methylene bis(4-isocyanatocyclohexane). The alkylene diisocyanates may be either linear or branched. Particular preference is given to isocyanurates which are based on n-hexamethylene diisocyanate, for example cyclic trimers, pentamers or higher oligomers of n-hexamethylene diisocyanate.

In general, component d2 is used in amounts from 0.01 to 5, preferably from 0.05 to 4 mol % and more preferably from 0.1 to 4 mol %, based on the sum total of the molar amounts of A and B.

Divinyl ether d3 can in general be any customary and commercially available divinyl ether. Preference is given to using 1,4-butanediol divinyl ether, 1,6-hexanediol divinyl ether or 1,4-cyclohexanedimethanol divinyl ether or mixtures thereof.

Divinyl ethers are preferably used in amounts from 0.01% to 5% and especially from 0.2% to 4% by weight, based on the total weight of A and B.

Examples of preferred partly aromatic polyesters are based on the following components:
A, B, d1
A, B, d2
A, B, d1, d2
A, B, d3
A, B, c1
A, B, c1, d3
A, B, c3, c4
A, B, c3, c4, c5
A, B, d1, c3, c5
A, B, c3, d3
A, B, c3, d1
A, B, c1, c3, d3
A, B, c2

Of these, partly aromatic polyesters based on A, B, d1 or A, B, d2 or on A, B, d1, d2 are particularly preferred. In another preferred embodiment, the partly aromatic polyesters are based on A, B, c3, c4, c5 or A, B, d1, c3, c5.

The partly aromatic polyesters mentioned and the inventive polyester mixtures are generally biodegradable.

As used herein, a material or composition of matter is said to be “biodegradable” when this material or composition of matter achieves not less than 60% biodegradation in at least one of the three processes defined in the German prestandard specification DIN V 54900-2 of September 1998.

Their biodegradability generally causes the polyester (mixtures) to disintegrate within an appropriate and verifiable interval. Degradation may be enzymatic, hydrolytic, oxidative and/or due to the action of electromagnetic radiation, for example UV radiation, and may be predominantly brought about by the action of microorganisms such as bacteria, yeasts, molds and algae. Biodegradability may be quantified for example by mixing polyesters with compost and storing the mixtures for a certain period. Process 3 of DIN V 54900-2, for example, requires that CO₂-free air be flowed through ripened compost during composting while the compost is subjected to a defined temperature program. Here, biodegradability is defined via the ratio of net CO₂ released by the sample (after deduction of CO₂ released by the compost without sample) to the maximum amount of CO₂ releasable by the sample (reckoned from the carbon content of the sample) as a percentage degree of biodegradation. Biodegradable polyester (mixtures) generally show clear signs of degradation, such as fungal growth, cracking and holing, after just a few days of composting.

Other methods for determining biodegradability are described for example in ASTM D 5338 and ASTM D 6400.

The production of partly aromatic polyesters is known per se or can be effected according to methods known per se.

Preferred partly aromatic polyesters are characterized by a molecular weight (Mₙ) in the range from 1000 to 100 000, especially in the range from 9000 to 75 000 g/mol and preferably in the range from 10 000 to 50 000 g/mol and a melting point in the range from 60 to 170° C. and preferably in the range from 80 to 150° C.

The partly aromatic polyesters mentioned may contain hydroxyl and/or carboxyl end groups in any desired ratio. The partly aromatic polyesters mentioned may also be end group modified. For instance, OH end groups may be acid modified by reaction with phthalic acid, phthalic anhydride, trimellitic acid, trimellitic anhydride, pyromellitic acid or pyromellitic anhydride.

Component ii of the biodegradable polyester mixture is in principle selected from renewables known per se. Useful renewables for the invention and their methods of making are known to one skilled in the art and are described for example in WO 93/23456 and EP-A2 897 943, which are expressly incorporated herein by reference.

Preferred renewables are polysaccharides of vegetable origin. Renewables further include cereals, i.e., cellulose-, lignin-, starch- and/or wood-comprising plant constituents, examples of which include comminuted or ground constituents of cereal grains and cereal chaff. Particularly preferred renewables are selected from the group consisting of starch, cellulose, lignin and wood, with starch being particularly suitable.

Renewables can be used not only in their naturally occurring form but also after derivatization, an example being destructurized starch. Starch is preferably used in its naturally occurring form, i.e., in its nondestructurized form. Renewables can be used for example in the form of fibers or powders.

Component iii of the biodegradable polyester mixtures can in principle be any compound which is capable of forming covalent bonds not only with component i but also with component ii. Compounds of this kind which are useful in the invention and their methods of making are known to one skilled in the art and are described for example in EP-A2 897 943, which is expressly incorporated herein by reference.

Preference for use as components iii is given to unsaturated organic carbon acids known per se or their derivatives. Particularly preferred components iii are one or more compounds selected from maleic acid, maleic anhydride, citraconic acid, citraconic anhydride, itaconic acid, itaconic anhydride, crotonic acid, isocrotonic acid, angelic acid, sorbic acid and acrylic acid. Maleic anhydride is especially preferred.

Preference for use as component iii is likewise given to organic acids of carbon (carboxylic acids) which are capable of forming unsaturated carboxylic acids by elimination of water, for example at elevated temperatures established when component i, ii and iii are mixed in kneaders or extruders. Particularly preferred components iii of this kind are citric acid, tartaric acid, malic acid and ascorbic acid.

Preferred components iii further include compounds which comprise two or more epoxy groups in the molecule. Of particular suitability are oligomeric or polymeric epoxidized compounds, for example di- or polyglycidyl esters of di- or polycarboxylic acids or di- or polyglycidyl ethers of di- or polyols, or copolymers of styrene and glycidyl (meth)acrylates as sold for example by Johnson Polymer under the brand name Joncryl® ADR 4368. Epoxidized soybean or linseed oils as sold for example by Henkel under the Edenol® brand are likewise particularly suitable.

Preferred components iii further include compounds which comprise at least one carbon-carbon double or triple bond and at least one epoxy group in the molecule. Glycidyl acrylate and glycidyl methacrylate are particularly suitable.

Biodegradable polyester mixtures according to the present invention comprise typically from 5% to 80% by weight, preferably from 10% to 70% by weight, more preferably from 15% to 60% by weight and especially from 20% to 50% by weight of component i and from 20% to 95% by weight, preferably from 30% to 90% by weight, more preferably from 40% to 85% by weight and most preferably from 50% to 80% by weight of component ii, the weight percentages each being based on the total weight of components i to ii and summing to 100% by weight.

Biodegradable polyester mixtures according to the present invention additionally comprise typically from 0.1% to 15% by weight, preferably from 0.5% to 10% by weight and more preferably from 1% to 10% by weight of component iii, the weight percentages each being based on the total weight of components i to ii.

Biodegradable polyester mixtures according to the present invention may comprise further ingredients which are known to one skilled in the art but which are not essential to the invention. Possible ingredients of this kind are for example biodegradable polymers other than components i and ii, such as aliphatic homo- or copolyesters, for example polylactide, polycaprolactone, polyhydroxyalkanoates or polyesters formed from aliphatic dicarboxylic acids and diols, or customary plastics technology additives such as stabilizers, neutralizing agents, lubricants, release agents, antiblocking agents, dyes or fillers.

Biodegradable polyester mixtures according to the present invention can be produced from the individual components according to known processes. Such processes are known to one skilled in the art and are described for example in EP-A2 897 943 and U.S. Pat. No. 4,762,890, which are expressly incorporated herein by reference.

For example, all the components i, ii and iii can be mixed and reacted in one process step in mixing apparatuses known to one skilled in the art, for example kneaders or extruders, at elevated temperatures, for example from 120° C. to 240° C. The reaction is preferably carried out in the presence of a free-radical initiator. Compounds useful as free-radical initiators, examples being organic peroxide or azo compounds, and amounts, are known to one skilled in the art and are described for example in EP-A2 897 943.

However, biodegradable polyester mixtures according to the present invention can also be produced in a process having a first step of component iii being mixed and, in the presence or absence of a free-radical initiator, reacted with one of the components i and ii, preferably component i, and a second step of the respectively still unused component ii or i, preferably component ii, being mixed in and reacted. Suitable materials, apparatuses and processes are known to one skilled in the art and are described for example in EP-A2 897 943.

Biodegradable polyester mixtures according to the present invention are particularly useful for producing blends, moldings, films, sheets or fibers. Production can be effected according to methods known to one skilled in the art.

A particular field of application for the biodegradable polyester mixtures having improved degradation rates is for the production of film and sheet, especially mulch films for agriculture. Such mulch films are applied to farmland to protect usually young seedlings. After harvesting, these mulch films are left on the fields or plowed under.

Substantially complete biodegradation of these mulch films by the start of next year's growing season is absolutely vital.

Biodegradable polyester mixtures according to the present invention provide biodegradable polymeric mixtures having a high fraction of inexpensive and ecologically safe renewables, good processing and mechanical properties and improved degradation rates.

### EXAMPLES

Testing:

The molecular weight Mₙ of partly aromatic polyester was determined as follows:

15 mg of partly aromatic polyester were dissolved in 10 ml of hexafluoroisopropanol (HFIP). 125 μl of each of these solutions were analyzed by gel permeation chromatography. (GPC). The measurements were carried out at room temperature. HFIP+0.05% by weight of potassium trifluoroacetate was used for elution. The elution rate was 0.5 ml/min. The column combination used was as follows (all columns from Showa Denko Ltd., Japan): Shodex® HFIP-800P (diameter 8 mm, length 5 cm), Shodex® HFIP-803 (diameter 8 mm, length 30 cm), Shodex® HFIP-803 (diameter 8 mm, length 30 cm). The partly aromatic polyester was detected using an RI detector (differential refractometry). Narrowly distributed polymethyl methacrylate standards having molecular weights Mₙ=505 to Mₙ=2 740 000 were used for calibration. Elution regions outside this interval were determined by extrapolation.

The melting temperatures of the partly aromatic polyesters were determined by DSC measurements using an Exstet DSC 6200R from Seiko:

From 10 to 15 mg of each sample were heated from −70° C. to 200° C. at a rate of 20° C./min under nitrogen. The melting temperature reported for a sample is the peak temperature of the melting peak observed. An empty sample crucible was used as a reference in each case.

The homogeneity of the mixtures of components i, ii, and iii and also of the comparative mixtures was determined by pressing each of these mixtures at 190° C. to form a film of 30 μm thickness. The fraction of undispersed component ii in these films was assessed by visual inspection.

The degradation rates of the biodegradable polyester mixtures and of the comparative mixtures were determined as follows:

The biodegradable polyester mixtures and the mixtures produced for comparison were each pressed at 190° C. to form films of 30 μm thickness. These films were each cut into square pieces having an edge length of 20 cm. The weight of each film piece was determined and defined as “100% by weight”. The film pieces were placed on a soil-filled trough in a conditioning cabinet for a period of four weeks, the soil having a moisture content (checked once a day) of about 40% based on the maximum water uptake capacity of the soil. Constant environmental conditions were set in the conditioning cabinet for these four weeks: a temperature of 30° C., a relative humidity of about 50% and 765 W/m² irradiation of the films in the wavelength range from 300 to 800 nm from a Heraeus SUNTEST accelerated exposure instrument. The remaining weight of each film piece was measured at weekly intervals and converted to % by weight (based on the weight determined at the start and defined as “100% by weight”).

Materials used:

Component i:
i-1: Polyester i-1 was produced by mixing 87.3 kg of dimethyl terephthalate, 80.3 kg of adipic acid, 117 kg of 1,4-butanediol and 0.2 kg of glycerol together with 0.028 kg of tetrabutyl orthotitanate (TBOT), the molar ratio between alcohol components and acid component being 1.30. The reaction mixture was heated to 180° C. and reacted at 180° C. for 6 h. The temperature was then raised to 240° C. and excess dihydroxy compound was distilled off under reduced pressure over a period of 3 h. Then 0.9 kg of hexamethylene diisocyanate was gradually metered in over 1 h at 240° C.

The thus obtained polyester i-1 had a melting temperature of 119° C. and a molecular weight (Mₙ) of 23 000 g/mol.

Component ii:

The following were used as component ii:
ii-1: Potato starch in powder form having an average particle diameter of 30 μm.
ii-2: Cellulose fibers having an average length of 45 μm and an average thickness of 25 μm and sold by J. Rettenmaier & Sohne GmbH & Co. under the brand name Abocell® FD600-30.

Component iii:

The material used as component iii was:
iii-1: maleic anhydride

Further components:

The following materials were used as a component to produce noninventive mixtures:
i-1-V: An aliphatic polyester, Cargill-Dow's Natureworks® 2000D polylactide.

Production and testing of inventive polyester mixtures and of comparative mixtures:

In a Rheocord® kneader from Haake operated at a speed of 50 rpm and at 160° C. under an argon atmosphere, in each case 50 g of component i-1 were melted, component iii-1 was added and the mixture was kneaded for 10 min. The ii-1 components were then added and kneading was continued at 160° C. for a further 10 min. The respective amounts of the iii-1 and ii-1 components were chosen so as to give the compositions reproduced in table 1. Component iii-1 was added in the form of a solution consisting of 1 part by weight of iii-1, one part by weight of methyl ethyl ketone and 0.03 part by weight of di-t-butyl peroxide.

The homogeneities determined by the above-described method for the mixtures obtained are likewise reported in table 1.

TABLE 1

| | ii-1 | ii-1 | ii-1 | ii-1 | ii-1 |
|---|---|---|---|---|---|
| | 20 wt %* | 40 wt %* | 60 wt %* | 70 wt %* | 80 wt %* |
| 0 wt %* | + | − | − | − | − |
| of iii-1 | | | | | |
| (for | | | | | |
| comparison) | | | | | |
| 1.0 wt %* | ++ | ++ | + | − | − |
| of iii-1 | | | | | |
| 1.5 wt %* | ++ | ++ | ++ | + | + |
| of iii-1 | | | | | |
| 3.0 wt %* | ++ | ++ | ++ | ++ | ++ |
| of iii-1 | | | | | |
| 5.0 wt %* | ++ | ++ | ++ | ++ | ++ |
| of iii-1 | | | | | |

*weight percentages are based on total weight of components i-1 and ii-1.
−: inhomogeneous mixture with large fractions of undispersed component ii-1
+: substantially homogeneous mixture having isolated pockets of undispersed component ii-1
++: homogeneous mixture having completely dispersed component ii-1

In a Rheocord® kneader from Haake operated at a speed of 60 rpm and at 160° C. under an argon atmosphere, in each case 50 g of component i-1 were melted, component iii-1 was added and the mixture was kneaded for 10 min. The ii-2 components were then added and kneading was continued at 160° C. for a further 10 min. The respective amounts of the iii-1 and ii-2 components were chosen so as to give the compositions reproduced in table 2. Component iii-1 was added in the form of a solution consisting of 1 part by weight of iii-1, one part by weight of methyl ethyl ketone and 0.03 part by weight of di-t-butyl peroxide.

The homogeneities determined by the above-described method for the mixtures obtained are likewise reported in table 2.

TABLE 2

| | ii-2 | ii-2 | ii-2 | ii-2 | ii-2 |
|---|---|---|---|---|---|
| | 20 wt %* | 40 wt %* | 60 wt %* | 70 wt %* | 80 wt %* |
| 0 wt %* | + | − | − | − | − |
| of iii-1 | | | | | |
| (for | | | | | |
| comparison) | | | | | |
| 1.0 wt %* | ++ | ++ | + | − | − |
| of iii-1 | | | | | |
| 1.5 wt %* | ++ | ++ | ++ | + | + |
| of iii-1 | | | | | |
| 3.0 wt %* | ++ | ++ | ++ | ++ | ++ |
| of iii-1 | | | | | |
| 5.0 wt %* | ++ | ++ | ++ | ++ | ++ |
| of iii-1 | | | | | |

*weight percentages are based on total weight of components i-1 and ii-2.
−: inhomogeneous mixture with large fractions of undispersed component ii-2
+: substantially homogeneous mixture having isolated pockets of undispersed component ii-2
++: homogeneous mixture having completely dispersed component ii-2

In a Rheocord® kneader from Haake operated at a speed of 60 rpm and at 190° C. under an argon atmosphere, in each case 50 g of component i-1 or i-1-V were melted, component iii-1 was added and the mixture was kneaded for 10 min. The ii-1 components were then added and kneading was continued at 190° C. for 10 min. The respective amounts of the iii-1 and ii-1 components were chosen so as to give the compositions reproduced in table 3. Component iii-1 was added in the form of a solution consisting of 1 part by weight of iii-1, one part by weight of methyl ethyl ketone and 0.03 part by weight of di-t-butyl peroxide.

The degradation rates** determined by the above-described method for the mixtures obtained are likewise reported in table 3.

TABLE 3

| | Degradation | Degradation | Degradation | Degradation | Degradation |
|---|---|---|---|---|---|
| | rate** after | rate** after | rate** after | rate** after | rate** after |
| | 0 weeks | 1 week | 2 weeks | 3 weeks | 4 weeks |
| Mixture | (wt %) | (wt %) | (wt %) | (wt %) | (wt %) |
| i-1-V, 50 wt %* | 100 | 95 | 89 | 82 | 78 |
| ii-1, 50 wt %* | | | | | |
| iii-1, 0 wt %* | | | | | |
| (for comparison) | | | | | |
| i-1-V, 50 wt %* | 100 | 98 | 94 | 91 | 87 |
| ii-1, 50 wt %* | | | | | |
| iii-1, 1.0 wt %* | | | | | |
| (for comparison) | | | | | |
| i-1, 50 wt %* | 100 | 95 | 87 | 70 | 52 |
| ii-1, 50 wt %* | | | | | |
| iii-1, 0 wt %* | | | | | |
| (for comparison) | | | | | |
| i-1, 50 wt %* | 100 | 94 | 72 | 53 | 31 |
| ii-1, 50 wt %* | | | | | |
| iii-1, 1.0 wt %* | | | | | |

*weight percentages are based on total weight of components i-1 (or i-1-V) and ii-1.
**degradation rate is defined as described at page 16 lines 13 to 15.

The tests show that the inventive polyester mixtures having a high fraction of renewables have good processing properties and improved degradation rates.

1. A biodegradable polyester mixture comprising
from 5% to 80% by weight, based on the total weight of components i to ii, of at least one polyester based on aliphatic and aromatic dicarboxylic acids and an aliphatic dihydroxy compound (component i) and
from 20% to 95% by weight, based on the total weight of components i to ii, of at least one renewable raw material (component ii) and
from 0.1% to 15% by weight, based on the total weight of components i to ii, of a glycidyl acrylate and/or glycidyl methacrylate as component iii.

2. The biodegradable polyester mixture according to claim 1 wherein said component i is polymerized from:
A) an acid component comprising
a1) from 30 to 99 mol % of at least one aliphatic or at least one cycloaliphatic dicarboxylic acid or its ester-forming derivatives or mixtures thereof
a2) from 1 to 70 mol % of at least one aromatic dicarboxylic acid or its ester-forming derivative or mixtures thereof and
a3) from 0 to 5 mol % of a sulfonated compound,
the mole percentages of said components al) to a3) adding up to 100% and
B) a diol component comprising at least one C₂- to C₁₂-alkanediol or a C₅- to C₁₀-cycloalkanediol or mixtures thereof
and if desired additionally one or more components selected from
C) a component selected from
c1) at least one dihydroxy compound which comprises ether functions and has the formula I
HO—[(CH₂)ₙ—O]ₘ—H (I)
where n is 2, 3 or 4 and m is an integer from 2 to 250,
c2) at least one hydroxy carboxylic acid of the formula Ia or IIb 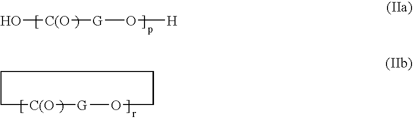
where p is an integer from 1 to 1500, r is an integer from 1 to 4 and G is a radical selected from the group consisting of phenylene, -(CH2)_{q}-, where q is an integer from 1 to 5, —C(R)H— and —C(R)HCH₂, where R is methyl or ethyl,
c3) at least one amino-C₂- to C₁₂-alkanol or at least one amino-C₅- to C₁₀-cycloalkanol or mixtures thereof
c4) at least one diamino-C₁- to C₈-alkane
c5) at least one 2,2′-bisoxazoline of the general formula III 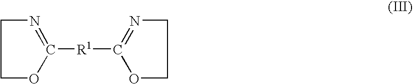
where R¹ is a single bond, a (CH₂)_{z}-alkylene group, where z=2, 3 or 4, or a phenylene group
c6) at least one amino carboxylic acid selected from the group consisting of the natural amino acids, polyamides obtainable by polycondensation of a dicarboxylic acid having from 4 to 6 carbon atoms and a diamine having from 4 to 10 carbon atoms, compounds of the formulae IV a and IVb 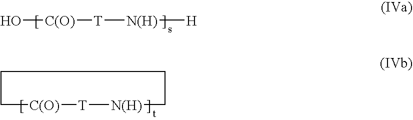
where s is an integer from 1 to 1500, t is an integer from 1 to 4 and T is a radical selected from the group consisting of phenylene, -(CH₂)ᵤ-, where u is an integer from 1 to 12, —C(R²)H— and —C(R²)HCH₂, where R² is methyl or ethyl,
and polyoxazolines containing the repeat unit V 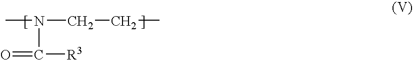
where R³ is hydrogen, C₁-C₆-alkyl, C₅-C₈-cycloalkyl, unsubstituted or C₁-C₄-alkyl-monosubstituted, -disubstituted or -trisubstituted phenyl or is tetrahydrofuryl,
or mixtures of c1) to c6) and
D) a component selected from
d1) at least one compound having at least three groups capable of ester formation,
d2) at least one isocyanate
d3) at least one divinyl ether
or mixtures of d1) to d3).

3. The biodegradable polyester mixture according to claim 1 wherein said component ii is one or more selected from the group consisting of starch, cellulose, lignin, wood and cereals.

4. The biodegradable polyester mixture according to claim 1 which comprises
from 10% to 70% by weight of said component i and
from 30% to 90% by weight of said component ii,
each percentage being based on the total weight of said components i to ii.

5. The biodegradable polyester mixture according to claim 1 which comprises from 0.5% to 10% by weight of said component iii, based on the total weight of said components i to ii.

6. A process for producing biodegradable polyester mixtures according to claim 1 which comprises said components i, ii and iii being in one step mixed and, in the presence or absence of a free-radical initiator, reacted.

7. A process for producing biodegradable polyester mixtures according to claim 1, which comprises a first step of said component iii being mixed with and, in the presence or absence of a free-radical initiator, reacted with one of said components i or ii and a second step of the hitherto unused component ii or i being mixed in and reacted.

8. The use of the biodegradable polyester mixtures according to claim 1 for producing blends, moldings, films, sheets or fibers.

9. Blends, moldings, films, sheets or fibers comprising biodegradable polyester mixtures according to claim 1.

10. The biodegradable polyester mixture according to claim 2 wherein said component ii is one or more selected from the group consisting of starch, cellulose, lignin, wood and cereals.

11. The biodegradable polyester mixture according to claim 2 which comprises
from 10% to 70% by weight of said component i and
from 30% to 90% by weight of said component ii,
each percentage being based on the total weight of said components i to ii.

12. The biodegradable polyester mixture according to claim 3 which comprises
from 10% to 70% by weight of said component i and
from 30% to 90% by weight of said component ii,
each percentage being based on the total weight of said components i to ii.

13. The biodegradable polyester mixture according to claim 2 which comprises from 0.5% to 10% by weight of said component iii, based on the total weight of said components i to ii.

14. The biodegradable polyester mixture according to claim 3 which comprises from 0.5% to 10% by weight of said component iii, based on the total weight of said components i to ii.

15. The biodegradable polyester mixture according to claim 4 which comprises from 0.5% to 10% by weight of said component iii, based on the total weight of said components i to ii.

16. A process for producing biodegradable polyester mixtures according to claim 2 which comprises said components i, ii and iii being in one step mixed and, in the presence or absence of a free-radical initiator, reacted.

17. A process for producing biodegradable polyester mixtures according to claim 3 which comprises said components i, ii and iii being in one step mixed and, in the presence or absence of a free-radical initiator, reacted.

18. A process for producing biodegradable polyester mixtures according to claim 4 which comprises said components i, ii and iii being in one step mixed and, in the presence or absence of a free-radical initiator, reacted.

19. A process for producing biodegradable polyester mixtures according claim 5 which comprises said components i, ii and iii being in one step mixed and, in the presence or absence of a free-radical initiator, reacted.

20. A process for producing biodegradable polyester mixtures according to claim 2, which comprises a first step of said component iii being mixed with and, in the presence or absence of a free-radical initiator, reacted with one of said components i or ii and a second step of the hitherto unused component ii or i being mixed in and reacted.
